(19) United States
(12) Patent Application Publication
(10) Pub. No.: US 2025/0248793 A1
(43) Pub. Date: Aug. 7, 2025

(54) Dental Prosthesis

(71) Applicant: Italo Lozada, Weston, FL (US)

(72) Inventor: Italo Lozada, Weston, FL (US)

(21) Appl. No.: 18/429,547

(22) Filed: Feb. 1, 2024

(51) Int. Cl. A61C 8/00; A61C 13/00

(52) U.S. Cl. CPC A61C 8/0036; A61C 8/0043; A61C 8/0051; A61C 13/0019

(57) ABSTRACT

A dental prosthesis is provided which is formed of a crown portion and a partial root portion. The prosthesis is more substantial than traditional crowns, and is sized and configured to fit closely within a root hole left from an extracted tooth. The partial root portion is able to be directly abutting the tissue of the patient, and does not rely on any other framework such as a portion of existing tooth, bone graft, and the like. An implant may be positioned through a channel defined in the prosthesis and the prosthesis may be installed at the same time as the implant.

### BACKGROUND OF THE INVENTION

The present disclosure relates generally to dental prostheses. More particularly the present disclosure relates to a dental prosthesis to replace a tooth which comprises of a crown as well as one or more root portions, the root portions fit into the space left from the extracted tooth and provides a safer, more stable, and more cosmetically appealing prosthesis compared to the prior art.

Generally, the installation of a dental prosthesis replicating a tooth is performed in two steps. The first step is the installation of a bone screw into a bone of a patient. This involves drilling a hole, and then setting a screw. This screw must then set for a period of time to allow the patient's body to adapt and accept the screw, and allow new bone growth in and around the screw. Only after this time period has elapsed can a replica tooth prosthesis (commonly called a “crown”) be installed by connecting it to this now secure screw. Usually this connection is via an adhesive. This process requires a substantial amount of a dentist's time, leading to higher costs. Further, the waiting period after the screw is implanted is uncomfortable and difficult for the patient. Further still, the bone target for screw installation, which will be drilled, is often not uniform, and is difficult to estimate. As such, the drilling may easily be off, causing a misaligned screw, or worse.

Traditional crowns replicate only the tooth part that extends from the gumline. This results in issues such as lack of hygiene under the tooth at the gum line, as well as visual imperfections such as being able to view the bottom of the crown. Moreover, when a tooth is extracted, the hole left must be packed with a bone graft. If not, the soft tissue gums—which grow faster than bone, grow into the opening, preventing the space from being filled with bone growth as is preferable. Bone grafting is expensive, complex, and uncomfortable for the patient.

Moreover, unguided drilling of the implant into the bone creates a number of additional difficulties such as maintaining proper drill orientation throughout the entire drilling process. Failure to do so can cause unwanted widening of the drilled hole as well as a non-straight and non-uniform hole.

Therefore, what is needed is a more effective and sophisticated dental prosthesis.

### SUMMARY OF THE INVENTION

The subject matter of this application may involve, in some cases, interrelated products, alternative solutions to a particular problem, and/or a plurality of different uses of a single system or article.

In one aspect, a dental prosthesis is provided. The prosthesis is formed of a crown having a top face and a bottom, and a partial root portion on the bottom of the crown. The partial root portion is root-shaped and has a cross-section to approximately match a root of a tooth being replaced. The partial root portion is shorter than the root of the tooth being replaced, such that the partial root portion may fit into a space left from the removed tooth being replaced, but does not fully fill the space left behind by the root of the extracted tooth.

In another aspect, a method of placing a fixed dental prosthesis is provided. The method involves positioning a dental prosthesis directly into an opening left from an extracted tooth. The prosthesis has of a crown having a top face and a bottom, and a partial root portion on the bottom of the crown. The partial root portion is root-shaped and has a cross-section to approximately match a root of a tooth being replaced. The partial root portion is shorter than the root of the tooth being replaced, such that the partial root portion may fit into a space left from the removed tooth being replaced, but does not fully fill the space left behind by the root of the extracted tooth. The partial root portion is the part of the prosthesis which is positioned into the opening and fits closely therein. The crown portion replicating a chewing and visible portion of the tooth extending above the gum-line and bone of the patient. The method further involves placing the implant screw through the channel, through the opening left from the extracted tooth, and into bone of a patient.

In yet another aspect, a method of forming a fixed dental prosthesis having a crown portion and a partial root portion is provided. The method involves performing an imaging procedure on a patient to identify size and shape of a tooth to be replaced with the fixed dental prosthesis. Next, the prosthesis is formed based on the imaging to match the extracted tooth, wherein the partial root portion is formed to have a cross section approximately the same as the extracted tooth, and formed to be shorter than the root portion of the extracted tooth to allow space for the placement of an implant.

### BRIEF DESCRIPTION OF DRAWINGS

FIG. 1 provides a perspective view of an embodiment of the present disclosure.

FIG. 2 provides an elevation view of another embodiment of the present disclosure.

FIG. 3 provides a cross sectional view of yet another embodiment of the present disclosure.

FIG. 4 provides a perspective view of yet still another embodiment of the present disclosure.

FIG. 5 provides a view of an embodiment of a ti-base of one embodiment of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a dental prosthesis which is formed of a crown portion and a partial root portion. The prosthesis is more substantial than traditional crowns, and is sized and configured to fit closely within a root hole left from an extracted tooth. The partial root portion is able to be directly abutting the tissue of the patient, and does not rely on any other framework such as a portion of existing tooth, bone graft, and the like. Depending on embodiment, the crown and partial root portion may be integrated as one unitary piece, or may be separated and attached during the placement procedure(s).

Once placed, the partial root portion provides additional support to the crown by its direct engagement with the bone of the patient. Also, the partial root portion provides an aesthetically superior appearance because it extends below the gumline of the patient, even if the gumline recedes. Cleanliness is improved because food and other items cannot get under the partial root portion. Further still, the close-fitting partial root portion partially (but not fully) fills the space left by the root, and has a cross section that matches or approximately matches the cross section of the root of the extracted tooth. When placed, soft tissue growth is blocked by the partial root portion, allowing the bone to grow into the cavity left by the root without the cavity being filled by soft tissue growth (which grows faster than bone and will overtake the space if not blocked). This eliminates the need for costly and complicated bone grafting-as is done in the prior art.

The prosthesis defines a guide hole (also referred to herein as a “channel”) from top to bottom (in most embodiment) which guides the positioning of an implant. The prosthesis is properly placed such that the partial root portion closely fits into the root hole opening, and then the implant is driven through the guide hole into the bone of the patient. This forms a fixed dental prosthesis which can be placed at the time of, or very shortly after the extraction of a tooth. This is different from the prior art which requires the placement of an implant, a long waiting period for the implant to set, and then attaching a crown to the implant. The partial root portion provides sufficient support to the crown to allow the placement of the prosthesis at the same time as the placement of the implant. The present disclosure relates to a fixed prosthesis, as defined below, which is not a temporary or removable prosthesis. Further, the prosthesis is a full replacement for a fully removed tooth and does not engage with or rely on a portion of an original tooth of the patient. This allows for a very efficient and satisfactory experience for the patient rather than having to wait a long time for the implants to set and relying on uncomfortable and inconvenient temporary solutions. In many embodiments, the step of extracting the tooth is performed on a same day or close to the same day as the step of positioning and placement of the implant and prosthesis.

As is known in the art, an implant (also referred to herein as a “screw”) preferably may be given a period of time to be accepted by the patient's body before it can fully support the dental prostheses (often referred to as a crown). This is because the patient's body takes time to accept the implanted screw, and grow bone around it to hold it securely in place. The screw contemplated herein may be any shaft, threaded or otherwise, capable of being implanted securely into a bone of a patient. The screw may be configured to set into a pre-drilled hole, may be self-driven (also called “self-drilling”), or self-tapping, among other options.

In embodiments wherein a tooth is being extracted and will soon after be replaced with a prosthesis, a 3D model may be taken of the tooth (prior to extraction), and then replicated such that the replacement tooth is a nearly identical replica of the original removed tooth. For example a 3D scan of a removed tooth of the patient may be taken using a computerized system. Based on this scan, the prosthesis may be generated automatically using a computer controlled system based on the scanned removed tooth. This generated replica may be formed as a crown only, or may comprise a partial or complete root for the tooth prosthesis.

In some embodiments, the present partial root prosthesis may also be used in patients who have had teeth removed and the bone has healed, closing the root hole. In such embodiments, a drill may be used on the healed site to create a hole in the bone sized to receive the partial root portion of the prosthesis. In such embodiments, the extension of the prosthesis material into the bone and beneath the gums will result in a substantial visual improvement compared to the prior art, among other advantages compared to the prior art as further discussed in this disclosure. In such embodiments using a drill to create or enlarge a root hole in the bone of a patient, it may be desirable to use a surgical guide to guide the drilling location and ensure that the opening has a proper size and orientation. Put another way, a separate surgical guide to direct the drill to a proper location may be used in many embodiments. In one embodiment, a first drilling may be performed and sized to receive the partial root portion, and a second drilling, which is more narrow than the first and concentric with the first, may be made deeper into the bone to receive the implant. As discussed further below, the guide hole of the prosthesis may then be used to guide the placement of the implant into the bone of the patient.

In one embodiment, a method of identifying the best area for bone drilling may include taking a 3D X-ray of the jaw or bone around the tooth to be replaced or the jaw area to place the prosthesis. This will provide a 3D model of the bone structure around the area to be drilled, and will allow identification of the best path the implant will take. Based on this, the tooth may be fabricated with the guide hole to guide the drill into the bone accordingly. However, it should be understood that any method to identify the best path for the implant may be used. It should be understood that the prosthesis guide hole may be configured based on the identified best area for drilling to control angle, width, and depth, thereby limiting damage and danger that can be done when drilling and/or setting the implant.

The dental prosthesis may be made of any material capable of being mounted within a mouth of the patient. Generally, the prosthesis may be any material typically used to make crowns and similar prostheses in the dental field. However, it should be understood that this invention is not limited to these materials.

Similarly, the implant (also referred to as a screw) may be any material capable of being screwed into bone and set therein. Generally, the screw may be made of typical medical or dental implant material such as zirconium, titanium, or the like. However, it should be understood that this invention is not limited to these materials.

The drill contemplated herein may be any drill capable of drilling into bone tissue. Any existing dental or medical drill may be used, as well as future innovations on such drilling devices.

Depending on embodiment, the partial root portion of the prosthesis may extend to varying depths in the jaw hole where the roots of the original tooth was. In one embodiment, the partial root portion may extend to at least 10% of the length of the root hole left by the original tooth. In another embodiment the partial root portion may extend to at least 25% of the length of the root hole left by the original tooth. In still another embodiment, the partial root portion may extend to at least 30% of the length of the root hole left by the original tooth. In yet another embodiment, the partial root portion may extend to at least 50% of the length of the root hole left by the original tooth. In still yet another embodiment, the partial root portion may extend to at least 50% of the length of the root hole left by the original tooth. Of course, these distances are only exemplary, and the partial root portion may extend any distance into the root hole. However, in preferred embodiments, the partial root portion has a length to extend into at least 10% of the root hole length, as measured from a top of the bone surface to a bottom of the tooth root hole.

In one embodiment, the partial root portion may be made of the same material as the crown portion of the prosthesis, such as zirconia, PEEK, and the like as used in the art. This provides for an aesthetically natural looking prosthesis. In such embodiments, bone growth in the hole left by the extracted tooth may stick, but does not grow into the partial root portion. In another embodiment, all or part of the partial root portion of the prosthesis may be made of a titanium or porous material. In such an embodiment, the bone of the jaw will grow into and bind with the partial root portion. In still other embodiment, the partial root portion may have an area formed of the same composite material as the crown portion, and may also have a titanium or porous material, allowing for bone in-growth at the titanium/porous portion.

Importantly, the present disclosure relates to a fixed dental prosthesis (also referred to in the art as a permanent dental prosthesis). This is distinguishable from a temporary prosthesis which is known in the art to be easily removably, even in some cases by a patient, and not designed for long term use. The term “fixed dental prosthesis” is a term of art known to those skilled in the art prior to the present application and means “a restoration that is not removable by the patient.” Terminology for Implant Prostheses, Simon et al., The International Journal of Oral & Maxillofacial Implants, Volume 18, Number 4 page 540, 2003 (“A fixed prosthesis can be defined as a restoration that is not removable by the patient.”). Further, the presently disclosed prosthesis is a full prothesis which replaces all of a patient's tooth, and is not designed or configured to be connected to any portion of an existing tooth.

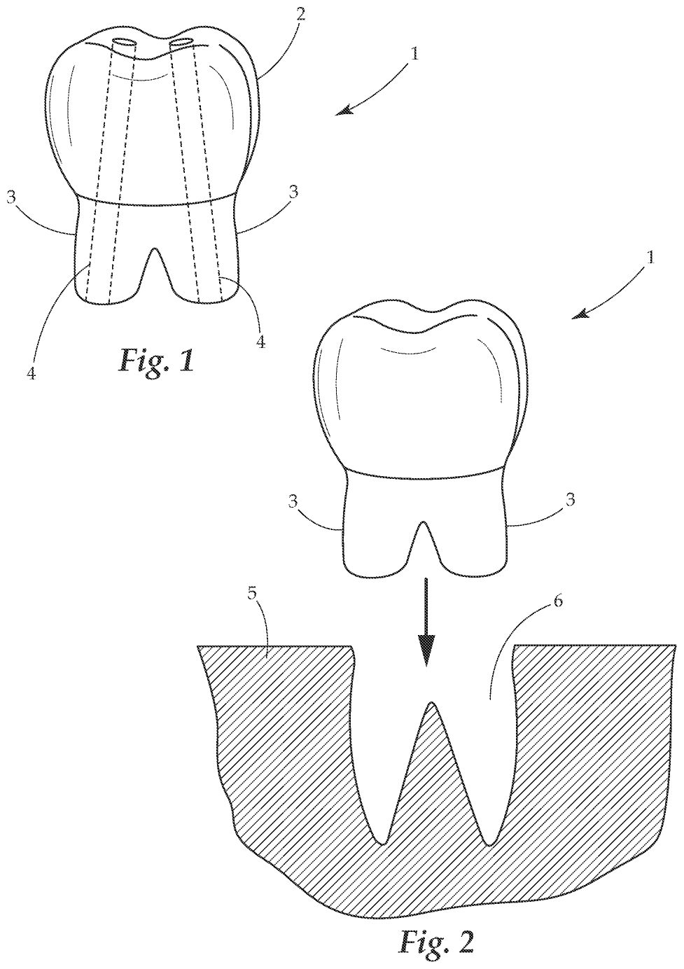

Turning now to FIG. 1, a view of an embodiment of the present disclosure is provided. The dental prosthesis 1 is formed having a crown 2 portion which is formed to replicate a top visible portion of a tooth to be replaced. The crown 2 has a top chewing face and a bottom. The prosthesis 1 further has a partial root portion 3. The partial root portion 3 is sized and configured to fit into a hole (or holes) left in a patient's bone after a tooth is extracted. The partial root portion has a cross section which matches or approximately matches the cross section of the hole left by the tooth. During the manufacture of the partial root portion, the sizing may be determined by imaging of the area around the tooth to be removed, such as via 3D x-ray and the like. In another embodiment, the sizing may be made after tooth extraction such that the root size is measured and then the partial root portion is manufactured to have the same, or approximately the same root size cross section. The crown 2 and partial root portion 3 define a channel 4 passing through from a top of the crown 2 to a bottom of the partial root portion 3. The channel 4 is formed to guide the placement of the implant into a portion of healthy bone capable of supporting the implant and prosthesis 1. While the embodiment of FIG. 1 is shown having two partial roots, it should be understood that other embodiments may include a prosthesis having one full root and one partial root, wherein the implant may only be placed through the partial root, or the prosthesis may have only one partial root, such as a front tooth prosthesis.

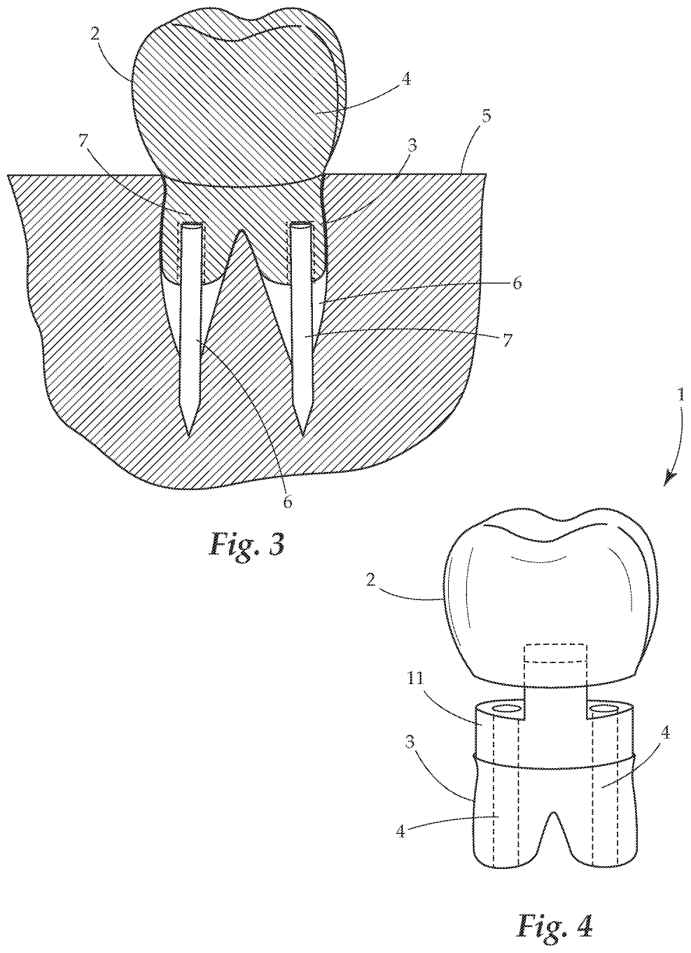

FIG. 2 shows another embodiment of the prosthesis contemplated herein being positioned in the patient's mouth. The prosthesis 1 having the partial root portion 3 fits via arrow into the root hole 6 left in the patient's bone after having a tooth extracted. As noted, the partial root portion 3 is sized to fit into this root hole 6 and abut, or nearly abut, a portion of the walls around the root hole. This provides stability to the prosthesis 1 when mounted and also blocks in-growth of soft tissue, allowing the bone to grow naturally into the hole 6. The partial root portion 3 extends beyond the top bone surface 5 a distance into the root hole 6. In the embodiment shown of a molar having two roots, it is preferable that the partial root portion 3 be long enough such that a partial root extends into each of the two holes left by the two roots. In other words, the partial root portion should have portions extending beyond the “fork” formed by the two roots.

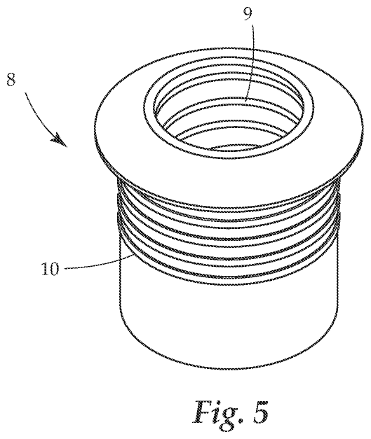

FIG. 3 provides a view of an embodiment of the dental prosthesis contemplated herein after the implants have been set into the bone of a patient. The crown 2 is visible above the bone 5 and gum line. Of course, in practice, other teeth will be adjacent, but are not shown for visibility purposes. The implants 7 extend from the guide holes 4 and in many cases are anchored therein, as well as extending into the bone of the patient and anchoring there. Typical embodiment will have the implant anchored to the partial root portion via, for example, threads, engagement of a implant head with a shoulder or taper, and the like. The implant 7 also extends through at least a portion of the root hole 6. Over time, this area will be filled with one growth which engages further with the implant 7. Connection of the implant 7, which is threaded and/or has a head or other wide-cross section part, may be by any structure capable of holding the implant to the prosthesis. In one embodiment, a threaded insert may be positioned within a part of the guide hole 4. The threaded insert may be a ti-base (See FIG. 5) which is a titanium or equivalent base structure having matching threads to the implant or a part of the implant; a shoulder, catch, or other mechanical structure to engage with a part of the implant. In another embodiment, the guide hole may have threads formed into it which can directly engage with the implant. In still another embodiment, the guide hole may have a shoulder formed into it which can engage with a head or other face of the implant. Combinations of these embodiments may also be employed. A top of the guide hole 4 is filled with a composite to seal the top of the crown 2 portion of the prosthesis.

FIG. 4 provides another embodiment of the dental prosthesis 1 having the crown 2 and partial root portion 3 initially formed as separate elements. In this embodiment, the guide holes 4 extend only through the partial root portion 3, and the crown 2 is later attached. In this case, the implants (not shown) are placed through the partial root portion 3 which is 3-D printed or otherwise artificially generated. Once the implants have been positioned, the crown 2 may be attached to the partial root portion 3 thus completing the prosthesis. In alternative embodiments, the prosthesis itself may define the channels to directly have the threads, shoulder, etc, formed into the inner wall of the channel to engage directly with the implant. The view of FIG. 4 could also be modified slightly to show the partial root portion 3 having an upwardly extended shape that may serve as an abutment 11. This abutment 11 can be formed of the same material as the partial root portion and/or crown and may be useful in various embodiments and use-cases. In another embodiment, the partial root prosthesis may be used for an anterior tooth. In such an embodiment, the guide hole 4 may extend through any portion, including commonly a front (anterior) face of the prosthesis. In such an embodiment, a veneer may be used to cover the guide hole and provide an aesthetically pleasing prosthesis.

The ti-base is seen in FIG. 5. The Ti-base 8 has a flange and elongate body that fits into the channel 4 and provides a surface for the implant to anchor to. Ti base 8 has a plurality of ridges 10 on its outer surface which help hold it in place against the inner wall of channel 4. Flange abuts the edge of the bottom of the channel 4 and limits over insertion. The inner threads 9 are sized to engage a corresponding thread of the implant outer surface. In other embodiments, the ti-base may have other engaging structures such as a shoulder, taper, and the like.

In additional embodiments, the entire tooth may be copied as a duplicate of the original tooth with the help of a CBCT with the exception of the most apical aspect of the length of the root of the tooth in question. When the access hole is on the esthetic zone either on occlusal or incisal edge of the body of the prosthetic tooth, or in other embodiments when preferred, the prosthesis may have two parts, a lower part (abutment) and a top portion (crown, veneer, and the like) which can cover the guide hole and be cemented or screwed onto the lower part.

In further embodiments, the present prosthesis may be formed as an abutment having a guide hole for the implant. In this embodiment, the abutment may be installed concurrently with the implant, using the abutment to guide the implant into the appropriate bone area. The abutment includes the partial root portion which fits into the space in the bone, and an upper portion above the gumline which can have a crown, veneer, etc, attached thereto. The abutment, in these embodiments, is formed of the same material as the crown, which is noted above. This abutment may be allowed to set and, once set, a permanent crown, or the like, may be installed on the abutment. In a similar embodiment, a temporary crown may be attached to the abutment at the time of installation of the screw and abutment. Once the implant has set, the temporary crown may be removed, and a permanent crown may be attached.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A dental prosthesis comprising:
a crown having a top face and a bottom; and
a partial root portion, the partial root portion is root-shaped and is sized to have a cross-section to approximately match a root of a tooth being replaced; and the partial root portion being shorter than the root of the tooth being replaced, such that the partial root portion may fit into a space left from the removed tooth being replaced; and
wherein the dental prosthesis is formed as a fixed dental prosthesis.

2. The dental prosthesis of claim 1 further comprising a channel extending through the partial root portion, the channel sized to receive a portion of an implant screw and configured to guide the implant placement.

3. The dental prosthesis of claim 2 further comprising the implant screw extending from the partial root portion.

4. The dental prosthesis of claim 2 wherein the channel extends through to the top face of the crown.

5. The dental prosthesis of claim 1 wherein the partial root portion comprises an abutment extending above a gumline area when placed, the crown attached to the abutment.

6. The dental prosthesis of claim 1 wherein the partial root portion has a length that is approximately 50% or less of the length of the root of the tooth being replaced.

7. The permanent dental prosthesis of claim 1 wherein the crown is removable from the partial root portion.

8. The dental prosthesis of claim 1 wherein the prosthesis is a full replacement for a fully removed tooth.

9. The dental prosthesis of claim 1 wherein the channel comprises one or more of threads and a shoulder formed by outer walls of the channel, the one or more of threads and the shoulder formed to engage with the implant screw.

10. The dental prosthesis of claim 1 wherein the channel comprises a ti-base configured to engage with the implant screw.

11. A method of placing a fixed dental prosthesis comprising the steps of:
positioning a dental prosthesis into an opening left from an extracted tooth, the prosthesis comprising:
a crown having a top face and a bottom; and
a partial root portion, the partial root portion being root-shaped and sized to have a cross-section to approximately match a root of a tooth being replaced; and the partial root portion being shorter than the root of the tooth being replaced, such that the partial root portion may fit into a space left from the removed tooth being replaced; and
a channel extending through the partial root portion, the channel sized to receive a portion of an implant screw;
placing the implant screw through the channel, through the opening left from the extracted tooth, and into bone of a patient;
wherein the step of positioning comprises causing the partial root portion to closely fit into the opening.

12. The method of claim 11 further comprising the step of extracting a tooth from a patient before the step of positioning.

13. The method of claim 12 wherein the step of extracting is performed on a same day as the step of positioning, and the step of placing the implant screw.

14. A method of forming a fixed dental prosthesis having a crown portion and a partial root portion comprising the steps of:
performing an imaging procedure on a patient to identify size and shape of a tooth to be replaced with the fixed dental prosthesis;
extracting the tooth;
forming the fixed dental prosthesis based on the imaging procedure to match the extracted tooth, wherein the partial root portion is formed to have a cross section approximately the same as the extracted tooth, and formed to be shorter than the root portion of the extracted tooth.

15. The method of claim 14 wherein the step of forming the fixed dental prosthesis further comprising the step of forming a channel extending through the partial root portion, the channel sized to receive a portion of an implant screw.

16. The method of claim 14 wherein the forming step is performed by 3-D printing.

17. The method of claim 14 wherein the step of forming the channel comprises forming channel to extend through to the top face of the crown.

18. The method of claim 14 wherein the forming step comprises forming the partial root portion to have a length that is approximately 50% or less of the length of the root of the tooth being replaced.

19. The method of claim 14 wherein the forming step comprises forming the channel to comprise one or more of threads and a shoulder formed by outer walls of the channel, the one or more of threads and the shoulder formed to engage with the implant screw.

20. The method of claim 14 wherein the forming step comprises forming the channel to comprise a ti-base configured to engage with the implant screw.
